(19) United States
(12) Patent Application Publication
(10) Pub. No.: US 2017/0212705 A1
(43) Pub. Date: Jul. 27, 2017

(54) Dynamic Weighting for Distributed Parity Device Layouts

(71) Applicant: NetApp, Inc., Sunnyvale, CA (US)

(72) Inventors: Kevin Kidney, Boulder, CO (US); Austin Longo, Boulder, CO (US)

(21) Appl. No.: 15/006,568

(22) Filed: Jan. 26, 2016

(51) Int. Cl. G06F 3/06

(52) U.S. Cl. CPC G06F 3/0631; G06F 3/0607; G06F 3/0689; G06F 3/067

(57) ABSTRACT

A system and method for improving the distribution of data extent allocation in dynamic disk pool systems is disclosed. A storage system includes a storage controller that calls a hashing function to select storage devices on which to allocate data extents when such is requested. The hashing function takes into consideration a weight associated with each storage device in the dynamic disk pool. Once a storage device is selected, the weight associated with that storage device is reduced by a predetermined amount. This reduces the probability that the selected storage device is selected at a subsequent time. When the data extent is de-allocated, the weight associated with the affected storage device containing the now-de-allocated data extent is increased by a predetermined amount. This increases the probability that the storage device is selected at a subsequent time.

### TECHNICAL FIELD

The present description relates to data storage systems, and more specifically, to a technique for the dynamic updating of weights used in distributed parity systems to more evenly distribute device selections for extent allocations.

### BACKGROUND

A storage volume is a grouping of data of any arbitrary size that is presented to a user as a single, unitary storage area regardless of the number of storage devices the volume actually spans. Typically, a storage volume utilizes some form of data redundancy, such as by being provisioned from a redundant array of independent disks (RAID) or a disk pool (organized by a RAID type). Some storage systems utilize multiple storage volumes, for example of the same or different data redundancy levels.

Some storage systems utilize pseudorandom hashing algorithms in attempts to distribute data across distributed storage devices according to uniform probability distributions. In dynamic disk pools, however, this results in certain “hot spots” where some storage devices have more data extents allocated for data than other storage devices. The “hot spots” result in potentially large variances in utilization. This can result in imbalances in device usage, as well as bottlenecks (e.g., I/O bottlenecks) and underutilization of some of the storage devices in the pool. This in turn can reduce the quality of service of these systems.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an organizational diagram of an exemplary architecture according to aspects of the present disclosure.

FIG. 3 is an organizational diagram of an exemplary distributed parity architecture when allocating extents on storage devices according to aspects of the present disclosure.

FIG. 4 is an organizational diagram of an exemplary distributed parity architecture when de-allocating extents from storage devices according to aspects of the present disclosure.

FIG. 5A is a diagram illustrating results of extent allocations without dynamic weighting.

FIG. 5B is a diagram illustrating results of extent allocations according to aspects of the present disclosure with dynamic weighting.

FIG. 6 is a flow diagram of a method for dynamically adjusting weights when allocating or de-allocating data extents according to aspects of the present disclosure.

FIG. 7 is a flow diagram of a method for dynamically adjusting weights when allocating or de-allocating data extents according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for improving the quality of service in dynamic disk pool (distributed parity) systems by ensuring a more evenly distributed layout of data extent allocation in storage devices. In an embodiment, whenever a data extent is to be allocated, a hashing function is called in order to select the storage device on which to allocate the data extent. The hashing function takes into consideration a weight associated with each storage device in the dynamic disk pool, so that it is more likely that devices having an associated weight that is larger are selected. Once a storage device is selected, the weight associated with that storage device is reduced by a pre-programmed amount that results in an incremental decrease. Further, any nodes at higher hierarchal levels (where a hierarchy is used) may also have weights whose values are a function of the storage device weights that are recomputed as well. This reduces the probability that the selected storage device is selected at a subsequent time.

When a data extent is de-allocated, such as in response to a request to delete the data at the data extent or to de-allocate the data extent, the storage system takes the requested action. When the data extent is de-allocated, the weight associated with the affected storage device containing the now-de-allocated data extent is increased by an incremental amount. Further, any nodes at higher hierarchal levels (where a hierarchy is used) may also have weights whose values are a function of the storage device weights that are recomputed as well based on the change. This increases the probability that the storage device is selected at a subsequent time.

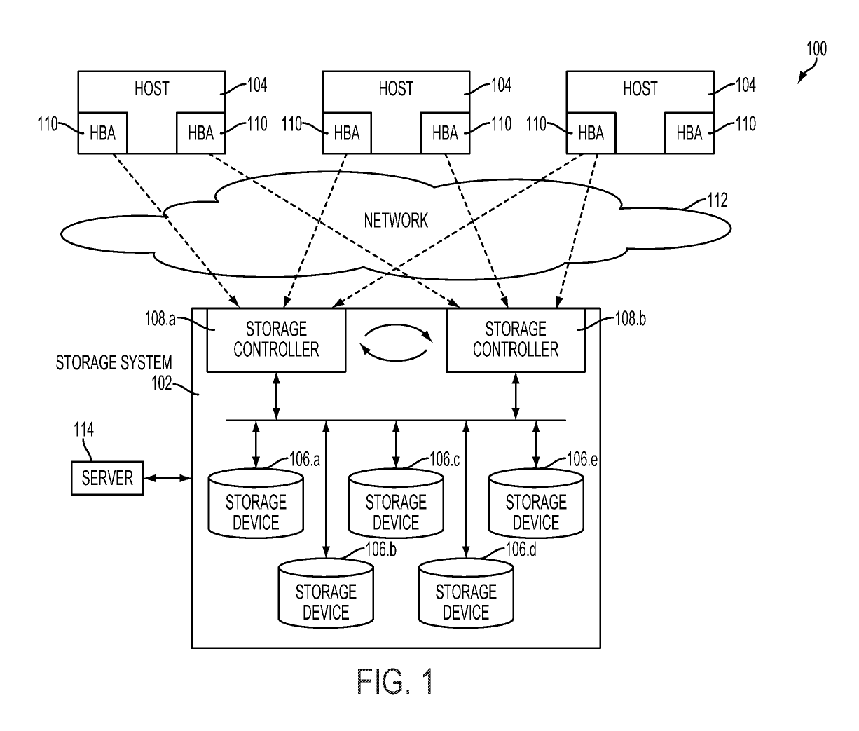

FIG. 1 illustrates a data storage architecture 100 in which various embodiments may be implemented. Specifically, and as explained in more detail below, one or both of the storage controllers 108.a and 108.b read and execute computer readable code to perform the methods described further herein to allocate and de-allocate extents and to correspondingly calculate respective weights and use those weights during allocation and de-allocation.

The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to write and/or read data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102.

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor, cause the processor to perform various operations described herein with the storage controllers 108.a, 108.b in the storage system 102 in connection with embodiments of the present disclosure. Instructions may also be referred to as code. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 and responds to one or more hosts 104's data transactions so that the storage devices 106 may appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, the storage system 102 may alternatively include a heterogeneous set of storage devices 106 that includes storage devices of different media types from different manufacturers with notably different performance.

The storage system 102 may group the storage devices 106 for speed and/or redundancy using a virtualization technique such as RAID or disk pooling (that may utilize a RAID level). The storage system 102 also includes one or more storage controllers 108.a, 108.b in communication with the storage devices 106 and any respective caches. The storage controllers 108.a, 108.b exercise low-level control over the storage devices 106 in order to execute (perform) data transactions on behalf of one or more of the hosts 104. The storage controllers 108.a, 108.b are illustrative only; more or fewer may be used in various embodiments. Having at least two storage controllers 108.a, 108.b may be useful, for example, for failover purposes in the event of equipment failure of either one. The storage system 102 may also be communicatively coupled to a user display for displaying diagnostic information, application output, and/or other suitable data.

In an embodiment, the storage system 102 may group the storage devices 106 using a dynamic disk pool (DDP) (or other declustered parity) virtualization technique. In a dynamic disk pool, volume data, protection information, and spare capacity are distributed across all of the storage devices included in the pool. As a result, all of the storage devices in the dynamic disk pool remain active, and spare capacity on any given storage device is available to all volumes existing in the dynamic disk pool. Each storage device in the disk pool is logically divided up into one or more data extents at various logical block addresses (LBAs) of the storage device. A data extent is assigned to a particular data stripe of a volume. An assigned data extent becomes a “data piece,” and each data stripe has a plurality of data pieces, for example sufficient for a desired amount of storage capacity for the volume and a desired amount of redundancy, e.g. RAID 0, RAID 1, RAID 10, RAID 5 or RAID 6 (to name some examples). As a result, each data stripe appears as a mini RAID volume, and each logical volume in the disk pool is typically composed of multiple data stripes.

In the present example, storage controllers 108.a and 108.b are arranged as an HA pair. Thus, when storage controller 108.a performs a write operation for a host 104, storage controller 108.a may also sends a mirroring I/O operation to storage controller 108.b. Similarly, when storage controller 108.b performs a write operation, it may also send a mirroring I/O request to storage controller 108.a. Each of the storage controllers 108.a and 108.b has at least one processor executing logic to perform writing and migration techniques according to embodiments of the present disclosure.

Moreover, the storage system 102 is communicatively coupled to server 114. The server 114 includes at least one computing system, which in turn includes a processor, for example as discussed above. The computing system may also include a memory device such as one or more of those discussed above, a video controller, a network interface, and/or a user I/O interface coupled to one or more user I/O devices. The server 114 may include a general purpose computer or a special purpose computer and may be embodied, for instance, as a commodity server running a storage operating system. While the server 114 is referred to as a singular entity, the server 114 may include any number of computing devices and may range from a single computing system to a system cluster of any size. In an embodiment, the server 114 may also provide data transactions to the storage system 102. Further, the server 114 may be used to configure various aspects of the storage system 102, for example under the direction and input of a user. Some configuration aspects may include definition of RAID group(s), disk pool(s), and volume(s), to name just a few examples.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108.a, 108.b of the storage system 102. The HBA 110 provides an interface for communicating with the storage controller 108.a, 108.b, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire.

The HBAs 110 of the hosts 104 may be coupled to the storage system 102 by a network 112, for example a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), the Internet, Fibre Channel, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., write, read, modify, etc.) remote data, a host HBA 110 sends one or more data transactions to the storage system 102. Data transactions are requests to write, read, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by writing, reading, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a WAN, and/or a LAN. Fibre Channel and FCoE are well suited for embodiments where hosts 104 are coupled to the storage system 102 via a direct connection or via Fibre Channel switches. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. As another example, embodiments of the present disclosure may utilize object-based storage, where objects are instantiated that are used to manage data instead of as blocks or in file hierarchies. In such systems, objects are written to the storage system similar to a file system in that when an object is written, the object is an accessible entity. Such systems expose an interface that enables other systems to read and write named objects, that may vary in size, and handle low-level block allocation internally (e.g., by the storage controllers 108.a, 108.b). It is understood that the scope of present disclosure is not limited to either block-level or file-level protocols or object-based protocols, and in many embodiments, the storage system 102 is responsive to a number of different memory transaction protocols.

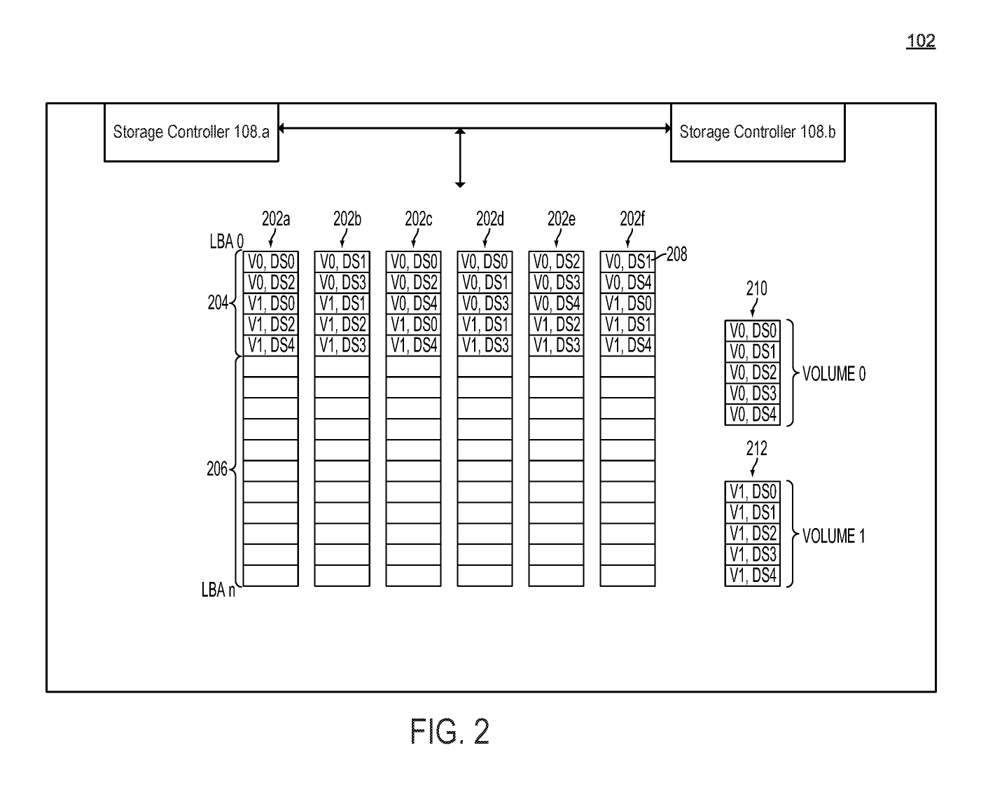

An exemplary storage system 102 configured with a DDP is illustrated in FIG. 2, which is an organizational diagram of an exemplary controller architecture for a storage system 102 according to aspects of the present disclosure. As explained in more detail below, various embodiments include the storage controllers 108.a and 108.b executing computer readable code to perform operations described herein.

FIG. 2 illustrates an organizational diagram of an exemplary architecture for a storage system 102 according to aspects of the present disclosure. In particular, FIG. 2 illustrates the storage system 102 being configured with a data pool architecture, including storage devices 202a, 202b, 202c, 202d, 202e, and 202f. Each of the storage controllers 108.a and 108.b may be in communication with one or more storage devices 202 in the DDP. In the illustrated embodiment, data extents from the storage devices 202a-202f are allocated into two logical volumes 210 and 212. More or fewer storage devices, volumes, and/or data extent divisions are possible than those illustrated in FIG. 2. For example, a given DDP may include dozens, hundreds, or more storage devices 202. The storage devices 202a-202f are examples of storage devices 106 discussed above with respect to FIG. 1.

Each storage device 202a-202f is logically divided up into a plurality of data extents 208. Of that plurality of data extents, each storage device 202a-202f includes a subset of data extents that has been allocated for use by one or more logical volumes, illustrated as data pieces 204 in FIG. 2, and another subset of data extents that remains unallocated, illustrated as unallocated extents 206 in FIG. 2. As shown, the volumes 210 and 212 are composed of multiple data stripes, each having multiple data pieces. For example, volume 210 is composed of 5 data stripes (V0:DS0 through V0:DS4) and volume 212 is composed of 5 data stripes as well (V1:DS0 through V1:DS4). Referring to DS0 of V0 (representing Data Stripe 0 of Volume 0, referred to as volume 210), it can be seen that there are three data pieces shown for purposes of illustration only.

Of these data pieces, at least one is reserved for redundancy (e.g., according to RAID 5; another example would be a data stripe with two data pieces/extents reserved for redundancy) and the others used for data. It will be appreciated that the other data stripes may have similar composition, but for simplicity of discussion will not be discussed here. According to embodiments of the present disclosure, an algorithm may be used by one or both of the storage controllers 108.a, 108.b to determine which storage devices 202 to select to provide data extents 208 from among the plurality of storage devices 202 that the disk pool is composed of. After a round of selection for storage devices' data extents for a data stripe, a weight associated with each selected storage device may be modified by the respective storage controller 108 to reduce the likelihood of those storage devices being selected next to create a next stripe. As a result, embodiments of the present disclosure are able to more evenly distribute the layout of data extent allocations in one or more volumes created by the data extents.

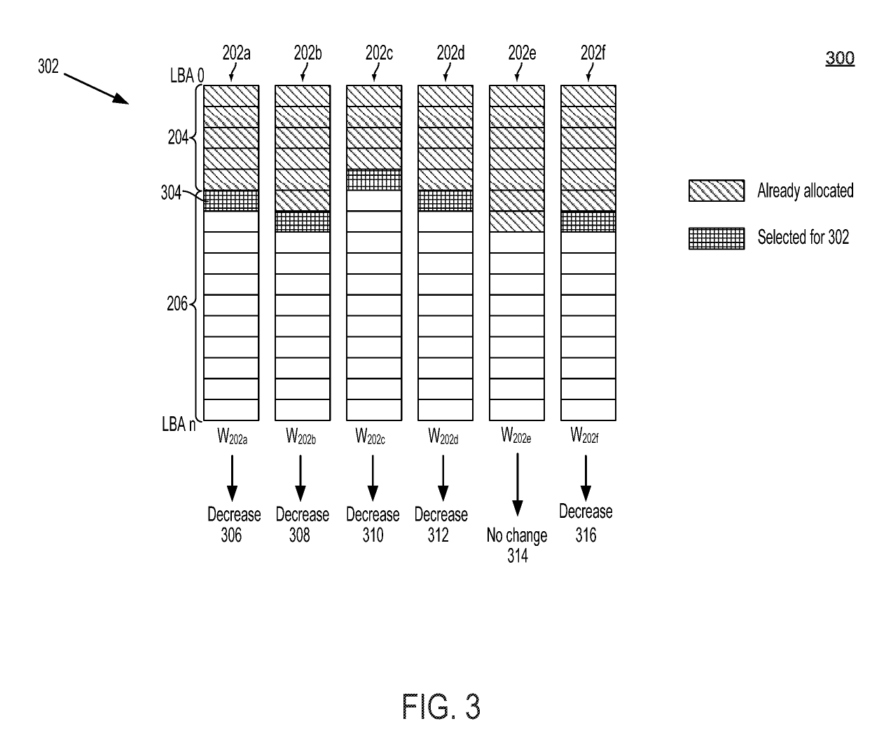

Turning now to FIG. 3, a diagram is illustrated of an exemplary distributed parity architecture when allocating extents on storage devices according to aspects of the present disclosure. For ease of description, the storage devices 202a-202f described above with respect to FIG. 2 will form the basis of the example discussed for FIG. 3. Each storage device 202 includes a weight (such as a numerical value) that is associated with it, for example as maintained by one or both of the storage controllers 108.a, 108.b (e.g., in a CPU memory, cache, and/or on one or more storage devices 202). For example, storage device 202a has a weight W₂₀₂ₐ associated with it, storage device 202b has a weight W_{202b} associated with it, storage device 202c has a weight W_{202c} associated with it, storage device 202d has a weight W_{202d} associated with it, storage device 202e has a weight W₂₀₂ₑ associated with it, and storage device 202f has a weight W_{202f} associated with it.

In an embodiment, each weight W may be initialized with a default value. For example, the weight may be initialized with a maximum value available for the variable the storage controller 108 uses to track the weight. In embodiments where object-based storage is used, for example, a member variable for weight, W, may be set at a maximum value (e.g., 0x10000 in base 16, or 65,536 in base 10) when the associated object is instantiated, for example corresponding to a storage device 202. This maximum value may be used to represent a device that has not allocated any of its capacity (e.g., has not had any of its extents allocated for one or more data stripes in a DDP) yet.

Continuing with this example, another variable (referred to herein as “ExtentWeight”) may also be set that identifies how much the weight variable W may be reduced for a given storage device 202 when an extent is allocated from that device (or increased when an extent is de-allocated). In an embodiment, the value for ExtentWeight may be a value proportionate to the total number of extents that the device supports. As an example, this may be determined by dividing the maximum value allocated for the variable W by the total number of extents on the given storage device, thus tying the amount that the weight W is reduced to the extents on the device itself. In another embodiment, the value for ExtentWeight may be set to be a uniform value that is the same in association with each storage device 202 in the DDP. This may give rise to a minimum theoretical weight W of 0 (though, to support a pseudo-random has-based selection processor, the minimum possible weight W may be limited to some value just above zero so that even a storage device 202 with all of its extents allocated may still show up for potential selection) and a maximum theoretical weight W equal to the initial (e.g., default) weight.

In an embodiment, the dynamic weighting may be tuned, i.e. turned on or off. Thus, when data extents are allocated and/or de-allocated, according to embodiments of the present disclosure the weights W associated with the selected devices are adjusted (decreased for allocations or increased for de-allocations) but the default value for the weight W may be returned whenever queried until the dynamic weighting is turned on. In a further embodiment, the weight W for each storage device 202 may be influenced solely by the default value and any decrements from that and increments to that (or, in other words, treating all storage devices 202 as though they generally have the same overall capacity, not considering the possible difference in size of the value set for ExtentWeight). In an alternative embodiment, in addition to dynamically adjusting the weight W based on allocation/de-allocation, the storage controller 108 may further set the weight W for each storage device 202 according to its relative capacity, so that different-sized storage devices 202 may have different weights W from each other before and during dynamic weight adjusting (or, alternatively, the different capacities may be taken into account with the size of ExtentWeight for each storage device 202).

As illustrated in FIG. 3, a request 302 to allocate one or more data extents (e.g., enough data extents to constitute a data stripe in the DDP) is received. This may be generated by the storage controller 108, itself, as part of a process to initialize a requested volume size before any I/O occurs. In another embodiment, the request 302 may come in the form of a write request from one or more hosts 104, such as where a volume on the DDP is a thin volume, and the write request triggers a need to add an additional data stripe to accommodate the new data. In response, the storage controller 108 proceeds with selecting the storage devices 202 to contribute data extents to the additional data stripe.

For example, in selecting storage devices 202 the storage controller 108 may utilize a logical map of the system, such as a cluster map, to represent what resources are available for data storage. For example, the cluster map may be a hierarchal map that logically represents the elements available for data storage within the distributed system (e.g., DDP), including for example data center locations, server cabinets, server shelves within cabinets, and storage devices 202 on specific shelves. These may be referred to as buckets which, depending upon their relationship with each other, may be nested in some manner. For example, the bucket for one or more storage devices 202 may be nested within a bucket representing a server shelf and/or server row, which also may be nested within a bucket representing a server cabinet. The storage controller 108 may maintain one or more placement rules that may be used to govern how one or more storage devices 202 are selected for creating a data stripe. Different placement rules may be maintained for different data redundancy types (e.g., RAID type) and/or hardware configurations

According to embodiments of the present disclosure, in addition to each of the storage devices 202 having a respective dynamic weight W associated with it, the buckets where the storage devices 202 are nested may also have dynamic weights W associated with them. For example, a given bucket's weight W may be a sum of the dynamic weights W associated with the devices and/or other buckets contained within the given bucket. The storage controller 108 may use these bucket weights W to assist in an iterative selection process to first select particular buckets from those available, e.g. selecting those with higher relative weights than the others according to the relevant placement rule for the given redundancy type/hardware configuration. For each selection (e.g., at each layer in a nested hierarchy), the storage controller 108 may use a hashing function to assist in its selection. The hashing function may be, for example, a multi-input integer has function. Other hash functions may also be used.

At each layer, the storage controller 108 may use the hash function with an input from the previous stage (e.g., the initial input such as a volume name for creation or a name of a data object for the system, etc.). The hash function may output a selection. For example, at a layer specifying buckets representing server cabinets, the output may be one or more server cabinets wherein the storage controller 108 may repeat selection for the next bucket down, such as for selecting one or more rows, shelves, or actual storage devices. With this approach, the storage controller 108 may be able to manage where a given volume is distributed across the DDP so that target levels of redundancy and failure protection (e.g., if power is cut to a server cabinet, data center location, etc.). At each iteration, the weight W associated with the different buckets and/or storage devices influences the selected result(s).

This iteration may continue until reaching the level of actual storage devices 202. This level is illustrated in FIG. 3, where the higher-level selections have already been made (e.g., which one or more data center locations from which to select storage devices, which one or more storage cabinets, etc.). According to the example in FIG. 3, the request 302 triggers the storage controller 108 to iterate through the nested bucket layers and, at the last layer, output from the function as a selection a number of storage devices 202 that will be responsive to the request 302. For example, when the request 302 is to create a data stripe for a volume, then the last iteration of using the hash function may be to select the number of storage devices 202 necessary such that each contributes one data extent to create the data stripe (e.g., a 4 GB stripe of multiple 512 MB-sized data extents).

Thus, in the example of FIG. 3 the result of the hash function output storage devices 202a, 202b, 202c, 202d, and 202f as the ones to provide data extents for the data stripe. According to embodiments of the present disclosure, storage device 202e was not selected during the hashing function because of its corresponding weight W. Since it had the largest number of data extents allocated relative to the other storage devices 202, the storage device 202e has the lowest relative weight W₂₀₂ₑ at the time of this selection. The selected data extents 304 are then allocated (e.g., to a data stripe or for specific data from a data object during an I/O request).

With the selection of specific storage devices 202a, 202b, 202c, 202d, and 202f complete (and subsequent allocation), the storage controller 108 then modifies the weights W associated with each storage device 202 impacted by the selection. Thus, the storage controller 108 decreases 306 the weight W₂₀₂ₐ, decreases 308 the weight W_{202b}, decreases 310 the weight W_{202c}, decreases 312 the weight W_{202d}, and decreases 316 the weight W_{202f} corresponding to the selected storage devices 202a, 202b, 202c, 202d, and 202f. As noted above, the weight for each may be reduced by ExtentWeight which may be the same for each storage device or different, e.g. depending upon the total number of extents on each storage device 202. Since the storage device 202e was not selected in this round, there is no change 314 in the weight W₂₀₂ₑ.

In addition to dynamically adjusting the weights W for the storage devices 202 affected by the selection, the storage controller 108 also dynamically adjusts the weights of those elements of upper hierarchal levels (e.g. higher-level buckets) in which the selected storage devices 202a, 202b, 202c, 202d, and 202f are nested. This can be accomplished by recomputing the sum of weights found within the respective bucket, which may include both the storage devices 202 as well as other buckets. As another example, after the weights W have been adjusted for the selected storage devices 202, the storage controller 108 may recreate a complete distribution of all nodes in the cluster map. Should another data stripe again be needed, e.g. another request 302 is received, the process described above is again repeated taking into consideration the dynamically changed weights from the previous round of selection for the different levels of the hierarchy in the cluster map. Thus, subsequent hashing into the cluster map (which may also be referred to as a tree) produce a bias toward storage devices 202 with higher weights W (those devices which have more unallocated data extents than the others).

The mappings may be remembered so that subsequent accesses take less time computationally to reach the appropriate locations among the storage devices 202. A result of the above process is that the extent allocations for subsequent data objects are more evenly distributed among storage devices 202 by relying upon the dynamic weights W according to embodiments of the present disclosure.

Although the storage devices 202a-202f are illustrated together, one or more of the devices may be physically distant from one or more of the others. For example, all of the storage devices 202 may be in close proximity to each other, such as on the same rack, etc. As another example, some of the storage devices 202 may be distributed in different server cabinets and/or data center locations (as just two examples) as influenced by the placement rules specified for the redundancy type and/or hardware configuration.

Further, although the above example discusses the reduction of weights W associated with the selected storage devices 202, in an alternative embodiment the weights W associated with the non-selected storage devices 202 may instead be increased, for example by the ExtentWeight value (e.g., where the default weights are all initialized to a zero value or similar instead of a maximum value), while the weight W for the selected storage devices 202 remain the same during that round.

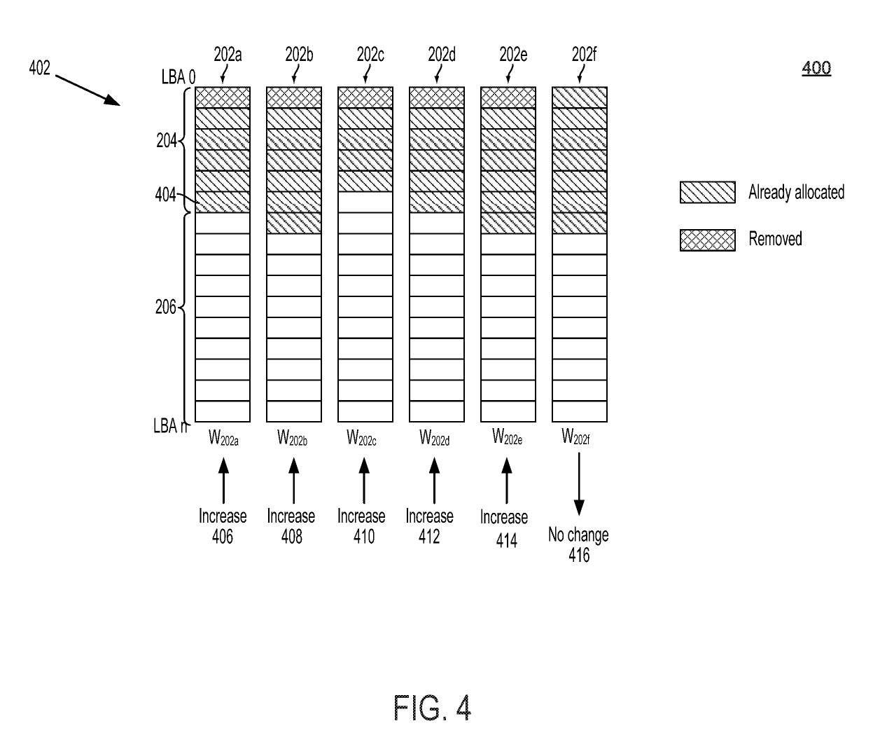

FIG. 4 is an organizational diagram of an exemplary distributed parity architecture when de-allocating extents from storage devices according to aspects of the present disclosure, which continues with the example introduced with FIGS. 2 and 3 above. At some point in time after certain data extents have been allocated on the different storage devices 202a-202f in FIG. 4, a request 402 to de-allocated one or more data extents is received. This may be in response to a request from a host 104 to delete specified data, delete a data stripe, move data to a different volume or storage devices, etc.

In the example illustrated in FIG. 4, the request 402 is to delete a data stripe that was stored on data extents associated with the storage devices 202a, 202b, 202c, 202d, and 202e (e.g., a 3+2 RAID 6 stripe or a 4+1 RAID 5 stripe as some examples). The storage controller 108 may follow the same iterative approach discussed above with respect to FIG. 3 to navigate the cluster map (e.g., one or more buckets) to arrive at the appropriate nodes corresponding to the necessary storage devices 202a, 202b, 202c, 202d, and 202e. The storage controller 108 may then perform the requested action specified with request 402. For example, where the requested action is a de-allocation, the now-de-allocated data extents may be identified as available for allocation to other data stripes and corresponding volumes, where upon subsequent allocation their weights may again be dynamically adjusted.

With the requested action completed at the storage devices 202a, 202b, 202c, 202d, and 202e, the storage controller 108 then modifies the weights W associated with each storage device 202 impacted by the action (e.g., de-allocation). Thus, in embodiments where the weights W are allocated to a default maximum value, the storage controller 108 increases 406 the weight W₂₀₂ₐ, increases 408 the weight W_{202b}, increases 410 the weight W_{202c}, increases 412 the weight W_{202d}, and increases 414 the weight W₂₀₂ₑ corresponding to the storage devices 202a, 202b, 202c, 202d, and 202e of this example. As noted above, the weight for each may be increased by ExtentWeight which may be the same for each storage device or different, e.g. depending upon the total number of extents on each storage device 202. Since the storage device 202f did not have an extent de-allocated, there is no change 416 in the weight W_{202f}.

In addition to dynamically adjusting the weights W for the storage devices 202 affected by the de-allocation, the storage controller 108 also dynamically adjusts the weights of those elements of upper hierarchal levels (e.g. higher-level buckets) in which the affected storage devices 202a, 202b, 202c, 202d, and 202e are nested. This can be accomplished by recomputing the sum of weights found within the respective bucket, which may include both the storage devices 202 as well as other buckets. As another example, after the weights W have been adjusted for the affected storage devices 202, the storage controller 108 may recreate a complete distribution of all nodes in the cluster map.

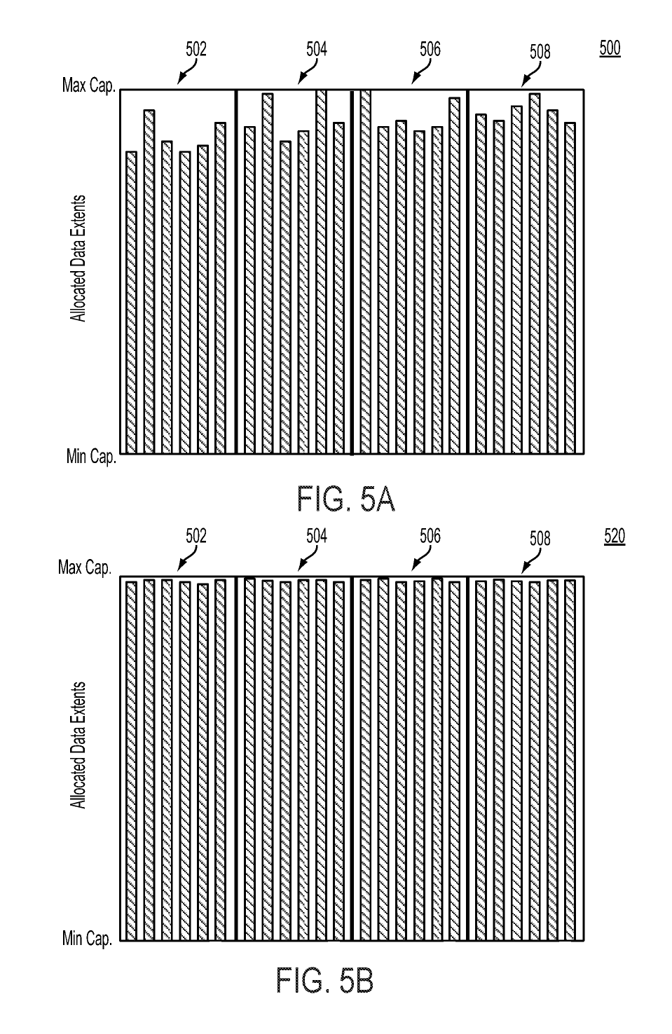

The difference in results between use of the dynamic weight adjustment according to embodiments of the present disclosure and the lack of dynamic weight adjustments is demonstrated by FIGS. 5A and 5B. FIG. 5A is a diagram 500 illustrating results of extent allocations without dynamic weighting and FIG. 5B is a diagram 520 illustrating results of extent allocations with dynamic weighting according to aspects of the present disclosure to contrast against diagram 500. As shown in both diagrams 500 and 520, each of diagrams 500 and 520 are split into several drawers 502, 504, 506, and 508. These may be represented by the cluster map discussed above as one or more buckets. Each drawer 502, 504, 506, and 508 has a number of storage devices 202 associated with them—in FIGS. 5A, 5B, each drawer has six bars representing respective storage devices 202 (or, in other words, six storage devices 202 per drawer). The drawers in diagrams 500, 520 have a minimum capacity that may corresponding to all of the data extents on a storage device 202 being unallocated, and a maximum capacity that may correspond to all of the data extents on a storage device 202 being allocated.

In diagram 500, without dynamic weighting it can be seen that using the hashing function with the cluster map, though it may operate to achieve an overall uniform distribution (e.g., according to a bell curve), may result in locally uneven distributions of allocation in the different drawers (illustrated at around 95% capacity). This may result in uneven performance differences between individual storage devices 202 (and, by implication, drawers, racks, rows, and/or cabinets for example). The contrast is illustrated in FIG. 5B, where data extents are allocated and de-allocated according to embodiments of the present disclosure using dynamic weight adjustment. As illustrated in FIG. 5B, at 95% capacity the variance between allocated extent amounts may be reduced as compared to FIG. 5A by around 97%, which may result in better performance. This in turn may drive a more consistent quality of performance according to one or more service level agreements that may be in place.

As a further benefit, in systems that are performance limited by drive spindles (e.g., random I/Os on hard disk drive storage devices), random DDP I/O may approximately match random I/O performance of RAID 6 (as opposed to system random read performance drops and random write performance drops when not utilizing dynamic weighting). Further, in systems that utilize solid state drives as storage devices, using the dynamic weighting may reduce the variation in wear leveling by keeping the data distribution more evening balanced across the drive set (as opposed to more uneven wear leveling that would occur as illustrated in diagram 500 of FIG. 5A).

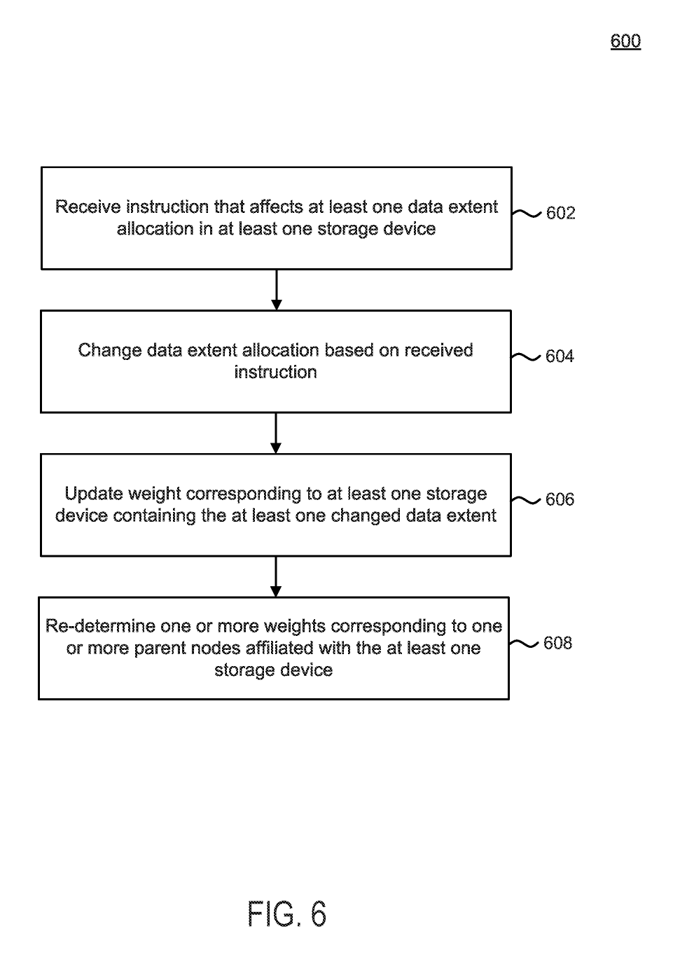

FIG. 6 is a flow diagram of a method 600 for dynamically adjusting weights when allocating or de-allocating data extents according to aspects of the present disclosure. In an embodiment, the method 600 may be implemented by one or more processors of one or more of the storage controllers 108 of the storage system 102, executing computer-readable instructions to perform the functions described herein. In the description of FIG. 6, reference is made to a storage controller 108 (108.a or 108.b) for simplicity of illustration, and it is understood that other storage controller(s) may be configured to perform the same functions when performing a pertinent requested operation. It is understood that additional steps can be provided before, during, and after the steps of method 600, and that some of the steps described can be replaced or eliminated for other embodiments of the method 600.

At block 602, the storage controller 108 receives an instruction that affects at least one data extent allocation in at least one storage device 202. For example, the instruction may be to allocate a data extent (e.g., for volume creation or for a data I/O). As another example, the instruction may be to de-allocate a data extent.

At block 604, the storage controller 108 changes the data extent allocation based on the instruction received at block 602. For extent allocation, this includes allocating the one or more data extents according to the parameters of the request. For extent de-allocation, this includes de-allocation and release of the extent(s) back to an available pool for potential later use.

At block 606, the storage controller 108 updates the weight corresponding to the one or more storage devices 202 affected by the change in extent allocation. For example, where a data extent is allocated, the weight corresponding to the affected storage device 202 containing the data extent is decreased, such as by ExtentWeight as discussed above with respect to FIG. 3. This reduces the probability that the storage device 202 is selected in a subsequent round. As another example, where a data extent is de-allocated, the weight corresponding to the affected storage device 202 containing the data extent is increased, such as by ExtentWeight as discussed above with respect to FIG. 4. This increases the probability that the storage device 202 is selected in a subsequent round.

At block 608, the storage controller 108 re-computes the weights associated with the one or more storage nodes, such as the buckets discussed above with respect to FIG. 3, based on the changes to the one or more affected storage devices 202 that are nested within those nodes.

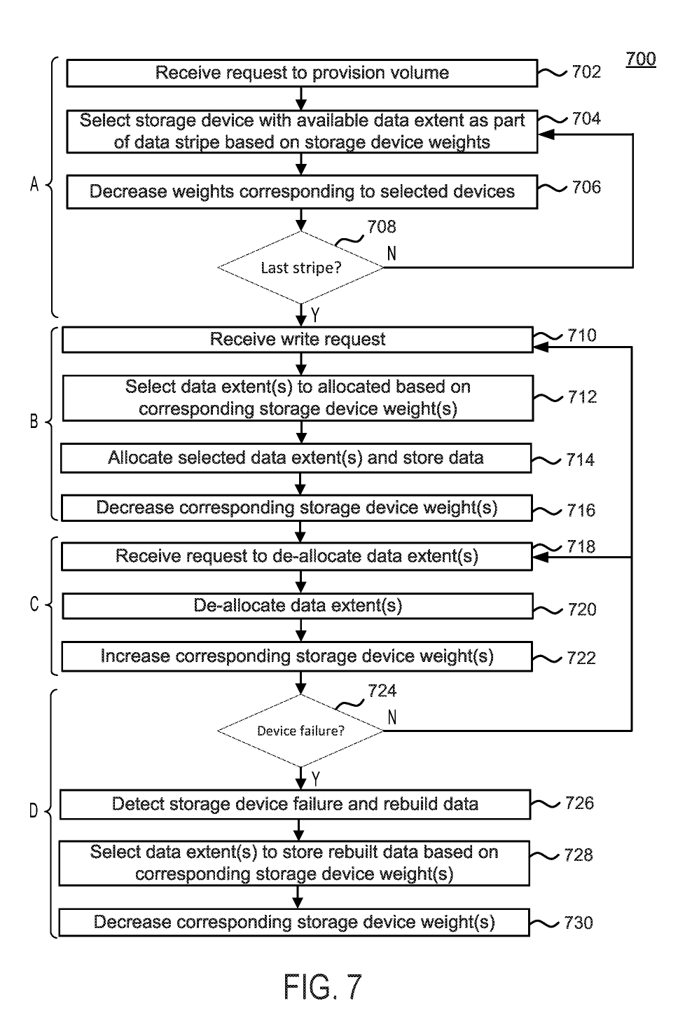

FIG. 7 is a flow diagram of a method 700 for dynamically adjusting weights when allocating or de-allocating data extents according to aspects of the present disclosure. In an embodiment, the method 700 may be implemented by one or more processors of one or more of the storage controllers 108 of the storage system 102, executing computer-readable instructions to perform the functions described herein. In the description of FIG. 7, reference is made to a storage controller 108 (108.a or 108.b) for simplicity of illustration, and it is understood that other storage controller(s) may be configured to perform the same functions when performing a pertinent requested operation.

The illustrated method 700 may be described with respect to several different phases identified as phases A, B, C, and D in FIG. 7. Phase A may correspond to a volume creation phase, phase B may correspond to a thin volume scenario during writes, phase C may correspond to a de-allocation phase, and phase D may correspond to a storage device failure and data recovery phase. It is understood that additional steps can be provided before, during, and after the steps of method 700, and that some of the steps described can be replaced or eliminated for other embodiments of the method 700. It is further understood that some or all of the phases illustrated in FIG. 7 may occur during the course of operation for a given storage system 102.

At block 702, the storage controller 108 receives a request to provision a volume in the storage system from available data extents in a distributed parity system, such as DDP.

At block 704, the storage controller 108 selects one or more storage devices 202 that have available data extents to create a data stripe for the requested volume. This selection is made, according to embodiments of the present disclosure, based on the present value of the corresponding weights for the storage devices 202. For example, the storage controller 108 calls a hashing function and, based on the weights associated with the devices, receives an ordered list of selected storage devices 202 from among those in the DDP (e.g., 10 devices from among a pool of hundreds or thousands).

At block 706, after the selection and allocation of data extents on the selected storage devices 202, the storage controller 108 decreases the weights associated with the selected storage devices 202. For example, the decrease may be according to the value of ExtentWeight, or some other default or computed amount. The storage controller 108 may also re-compute the weights associated with the one or more storage nodes in which the selected storage devices 202 are nested.

At decision block 708, the storage controller 108 determines whether the last data stripe has been allocated for the volume requested at block 702. If not, then the method 700 returns to block 704 to repeat the selection, allocation, and weight adjusting process. If so, then the method 700 proceeds to block 710.

At block 710, which may occur during regular system I/O operation in phase B, the storage controller 108 may receive a write request from a host 104.

At block 712, the storage controller 108 responds to the write request by selecting one or more storage devices 202 on which to allocate data extents. This selection is made based on the present value of the weights associated with the storage devices 202 under consideration. This may be done in addition, or as an alternative to, the volume provisioning already done in phase A. For example, where the volume is provisioned at phase A but done by thin provisioning, there may still be a need to allocate additional data extents to accommodate the incoming data.

At block 714, the storage controller 108 allocates the data extents on the selected storage devices from block 712.

At block 716, the storage controller 108 decreases the weights associated with the selected storage devices 202. For example, the decrease may be according to the value of ExtentWeight, or some other default or computed amount. The storage controller 108 may also re-compute the weights associated with the one or more storage nodes in which the selected storage devices 202 are nested.

At block 718, which may occur during phase C, the storage controller 108 receives a request to de-allocate one or more data extents. This may correspond to a request to delete data stored at those data extents, or to a request to delete a volume, or to a request to migrate data to other locations in the same or different volume/system.

At block 720, the storage controller 108 de-allocates the requested data extents on the affected storage devices 202.

At block 722, the storage controller 108 increases the weights corresponding to the affected storage devices 202 where the de-allocated data extents are located. This may be according to the value of ExtentWeight, as discussed above with respect to FIG. 4.

The method 700 then proceeds to decision block 724, part of phase C. At decision block 724, it is determined whether a storage device has failed. If not, then the method may return to any of phases A, B, and C again to either allocate for a new volume, for a data write, or de-allocated as requested.

If it is instead determined that a storage device 202 has failed, then the method 700 proceeds to block 726.

At block 726, as part of data reconstruction recovery efforts, the storage controller 108 detects the storage device failure and initiates data rebuilding of data that was stored on the now-failed storage device. In systems that rely on parity for redundancy, this includes recreating the stored data based on the parity information and other data pieces stored that relate to the affected data.

At block 728, the storage controller 108 selects one or more available (working) storage devices 202 on which to store the rebuilt data. This selection is made based on the present value of the weights associated with the storage devices 202 under consideration. The storage controller 108 then allocates the data extents on the selected storage devices 202.

At block 730, the storage controller 108 decreases the weights associated with the selected storage devices 202. For example, the decrease may be according to the value of ExtentWeight, or some other default or computed amount. The storage controller 108 may also re-compute the weights associated with the one or more storage nodes in which the selected storage devices 202 are nested.

As a result of the elements discussed above, a storage system's performance is improved by reducing the variance of capacity between storage devices in a volume, improving quality of service with more evenly distributed data extent allocations. Further, random I/O performance is improved and improved wear leveling between devices.

The present embodiments can take the form of a hardware embodiment, a software embodiment, or an embodiment containing both hardware and software elements. In that regard, in some embodiments, the computing system is programmable and is programmed to execute processes including the processes of methods 600 and/or 700 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include for example non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
selecting, by a storage system, a storage device from among a plurality of storage devices based on a weight associated with each storage device on which to allocate a data extent, the weight indicating a preferred likelihood of selection;
allocating, by the storage system, the data extent on the selected storage device; and
decreasing, by the storage system, the weight associated with the selected storage device in response to allocation of the data extent on the selected storage device.

2. The method of claim 1, further comprising:
de-allocating, by the storage system, the data extent from the selected storage device; and
increasing, by the storage system, the weight associated with the selected storage device in response to the de-allocation.

3. The method of claim 2, further comprising:
performing, by the storage system, the selecting, allocating, and decreasing in response to a data input request to an existing volume; and
performing, by the storage system, the de-allocating and the increasing in response to a data removal request to the existing volume.

4. The method of claim 1, further comprising:
receiving, by the storage system before selecting the storage device, a request to allocate the data extent as part of a request for creation of a volume, the volume comprising one or more data stripes in which the data extent is located.

5. The method of claim 4, further comprising:
selecting, by the storage system, a plurality of data extents on a plurality of corresponding storage devices to allocate based on the weight associated with each storage device to create a data stripe in the volume;
decreasing, by the storage system, the respective weights associated with the plurality of selected storage devices corresponding to the plurality of data extents constituting the data stripe; and
repeating, by the storage system, the selecting and decreasing after creating each data stripe until the one or more data stripes in the volume are allocated.

6. The method of claim 1, further comprising:
detecting, by the storage system, a failure of another storage device from among the plurality of storage devices; and
performing, by the storage system, the selecting, allocating, and decreasing in response to the detecting the failure to place data reconstructed from the failed storage device.

7. The method of claim 1, wherein the weight associated with each storage device comprises a first component influenced by an allocation or de-allocation of a data extent on each respective storage device and a second component influenced by a total capacity of each respective storage device.

8. A non-transitory machine readable medium having stored thereon instructions for performing a method comprising machine executable code which when executed by at least one machine, causes the machine to:
receive a request to allocate a data extent on a storage device as part of a data stripe;
select a storage device from among a plurality of storage devices to allocate the data extent based on a weight associated with each storage device from among the plurality, the weight indicating a preferred likelihood of selection;
allocate the data extent on the selected storage device; and
decrease the weight associated with the selected storage device in response to the allocation.

9. The non-transitory machine readable medium of claim 8, further comprising machine executable code that causes the machine to:
receive a request to de-allocate the data extent on the storage device;
de-allocate the data extent from the storage device; and
increase the weight associated with the selected storage device in response to the de-allocation.

10. The non-transitory machine readable medium of claim 8, further comprising machine executable code that causes the machine to:
allocate a plurality of data extents on a subset of storage devices from among the plurality of storage devices as part of the data stripe, each storage device in the subset being selected based on their respective weights; and
decrease the respective weights associated with the subset of storage devices in response to the allocation.

11. The non-transitory machine readable medium of claim 10, wherein the data stripe comprises a first data stripe and the subset of storage devices comprises a first subset of storage devices, further comprising machine executable code that causes the machine to:
receive a request to create a second data stripe; and
select a second subset of storage devices from among the plurality of storage devices, taking into consideration the decreased respective weights associated with the first subset of storage devices,
wherein one or more storage devices in the second subset may overlap with one or more in the first subset of storage devices.

12. The non-transitory machine readable medium of claim 11, further comprising machine executable code that causes the machine to:
allocate a second plurality of data extents on the second subset of storage devices; and
decrease respective weights associated with the second subset of storage devices in response to the allocation.

13. The non-transitory machine readable medium of claim 8, further comprising machine executable code that causes the machine to:
receive the request to allocate the data extent in response to a data input request to a thinly-provisioned volume, the data stripe comprising an addition to the thinly-provisioned volume after allocation.

14. The non-transitory machine readable medium of claim 8, wherein the weight associated with each storage device comprises a first component influenced by an allocation or de-allocation of a data extent on each respective storage device and a second component influenced by a total capacity of each respective storage device.

15. A computing device comprising:
a memory containing machine readable medium comprising machine executable code having stored thereon instructions for performing a method of distributing data extent allocations among a plurality of storage devices;
a processor coupled to the memory, the processor configured to execute the machine executable code to cause the processor to:
detect a change in a data extent allocation status at a storage device from among the plurality of storage devices, the storage device being logically grouped into at least one parent node;
update, in response to the detected change in data extent allocation status, an assigned weight corresponding to the storage device, the weight indicating a preferred likelihood of selection for data extent allocation; and
recompute, based on the update, a parent node weight for the at least one parent node that includes the assigned weight.

16. The computing device of claim 15, wherein the detected change comprises a selection and allocation of a data extent at the storage device, the machine executable code further causing the processor, as the update, to:
decrease the assigned weight corresponding to the storage device.

17. The computing device of claim 16, wherein the detection, update, and recomputation occur during creation and allocation of a volume.

18. The computing device of claim 15, wherein the detected change comprises a de-allocation of a data extent at the storage device, the machine executable code further causing the processor, as the update, to:
increase the assigned weight corresponding to the storage device.

19. The computing device of claim 18, wherein the detection, update, and recomputation occur during regular input/output operations after initial volume allocation.

20. The computing device of claim 15, wherein the parent node logically includes one or more other storage devices from among the plurality of storage devices in a storage hierarchy.
